(19) United States
(12) Patent Application Publication
(10) Pub. No.: US 2017/0353905 A1
(43) Pub. Date: Dec. 7, 2017

(54) ACCESS POINT ROAMING

(71) Applicant: QUALCOMM Incorporated, San Diego, CA (US)

(72) Inventors: Rajeev KUMAR, San Diego, CA (US); Dhananjai SINGH, San Jose, CA (US); Rajagopal JEENAGALA, San Diego, CA (US)

(21) Appl. No.: 15/172,999

(22) Filed: Jun. 3, 2016

(51) Int. Cl. H04W 36/32; H04W 36/08; H04W 84/12

(52) U.S. Cl. CPC H04W 36/32; H04W 36/08; H04W 84/12

(57) ABSTRACT

Certain aspects of the present disclosure relate to methods and apparatus for selecting access points. One example method, performed by a wireless device, generally includes storing information indicative of location of a plurality of access points comprising a first access point. The method further includes storing information indicative of a first subset of a plurality of channels used by the first access point. The method further includes determining, based on the information indicative of location of the plurality of access points, the wireless device is near the first access point. The method further includes scanning the first subset of the plurality of channels based on determining the wireless device is near the first access point and the information indicative of the first subset.

### FIELD

Certain aspects of the present disclosure generally relate to wireless communications and, more particularly, to techniques for selecting access points when roaming.

### BACKGROUND

Wireless communication systems have become more and more ubiquitous. In particular, multiple access points may be found in a number of locations that provide access to networks (e.g., the Internet) to user terminals. For example, access points that implement the Institute of Electrical and Electronics Engineers (IEEE) 802.11 standard are found in any number of places around the world. IEEE 802.11 denotes a set of Wireless Local Area Network (WLAN) air interface standards developed by the IEEE 802.11 committee for short-range communications (e.g., tens of meters to a few hundred meters).

In any given location, there may be multiple access points that a user terminal can connect communicate with. The user terminal, therefore, may need to select a particular access point from the multiple access points to communicate with.

### SUMMARY

Certain aspects of the present disclosure provide a method of wireless communication by a wireless device. The method comprises storing information indicative of location of a plurality of access points comprising a first access point. The method further comprises storing information indicative of a first subset of a plurality of channels used by the first access point. The method further comprises determining, based on the information indicative of location of the plurality of access points, the wireless device is near the first access point. The method further comprises scanning the first subset of the plurality of channels based on determining the wireless device is near the first access point and the information indicative of the first subset.

Certain aspects of the present disclosure provide a wireless device. The wireless device comprises a memory configured to store information indicative of location of a plurality of access points comprising a first access point. The memory is further configured to store information indicative of a first subset of a plurality of channels used by the first access point. The wireless device further comprises a processor configured to determine, based on the information indicative of location of the plurality of access points, the wireless device is near the first access point. The processor is further configured to scan the first subset of the plurality of channels based on determining the wireless device is near the first access point and the information indicative of the first subset.

Certain aspects of the present disclosure provide a wireless device. The wireless device comprises means for storing information indicative of location of a plurality of access points comprising a first access point. The wireless device further comprises means for storing information indicative of a first subset of a plurality of channels used by the first access point. The wireless device further comprises means for determining, based on the information indicative of location of the plurality of access points, the wireless device is near the first access point. The wireless device further comprises means for scanning the first subset of the plurality of channels based on determining the wireless device is near the first access point and the information indicative of the first subset.

### BRIEF DESCRIPTION OF THE DRAWINGS

FIG. 1 illustrates a diagram of a wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates a diagram of a wireless communications network, in accordance with certain aspects of the present disclosure.

FIG. 5 illustrates example operations for selecting access points, in accordance with certain aspects of the present disclosure.

### DETAILED DESCRIPTION

According to aspects of the present disclosure, systems and techniques are provided to select access points when roaming.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The word “exemplary” is used herein to mean “serving as an example, instance, or illustration.” Any aspect described herein as “exemplary” is not necessarily to be construed as preferred or advantageous over other aspects.

The multi-antenna transmission techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement IEEE 802.11 or some other standards. A TDMA system may implement GSM or some other standards. These various standards are known in the art.

### An Example Wireless Communications System

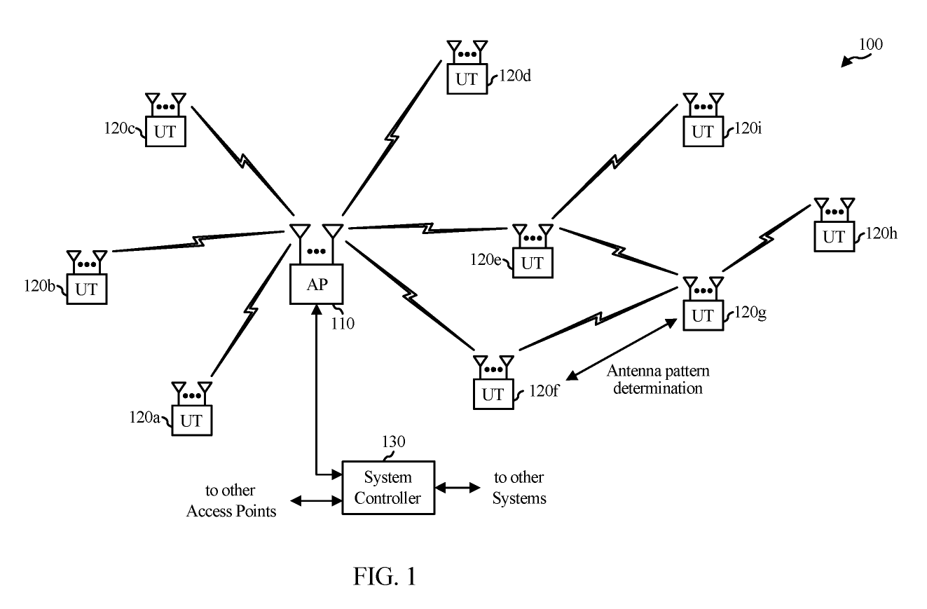

FIG. 1 illustrates a wireless communications network 100 with access points and user terminals. For simplicity, only one access point 110 is shown in FIG. 1. An access point (AP) is generally a fixed station that communicates with the user terminals and may also be referred to as a base station or some other terminology. A user terminal may be fixed or mobile and may also be referred to as a mobile station, a station (STA), a client, a wireless device, or some other terminology. A user terminal may be a wireless device, such as a cellular phone, a personal digital assistant (PDA), a handheld device, a wireless modem, a laptop computer, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points. Each selected user terminal transmits user-specific data to and/or receives user-specific data from the access point.

In certain aspects, a user terminal 120 may be in communication range with multiple APs 110. Accordingly, the user terminal 120 may need to determine which AP 110 to communicate with. In certain aspects, techniques are described herein for a user terminal 120 to select an AP 110 to communicate with based on a congestion level of the AP 110 and/or a congestion level of a channel that the AP 110 communicates on.

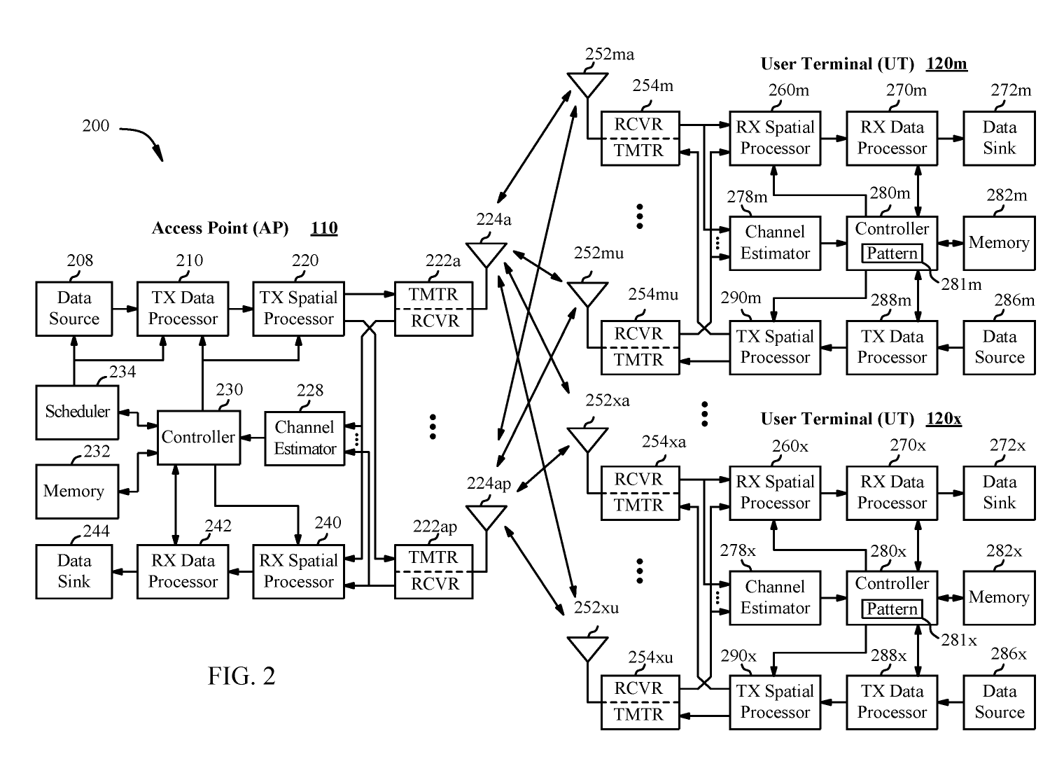

FIG. 2 shows a block diagram of access point 110 and two user terminals 120m and 120x in wireless communications network 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. In certain aspects, each of the AP 110 and the user terminal 120 may communicate on one or more such frequency channels (also referred to as “channels”). Such channels may become congested due to communications by multiple APs 110 and user terminals 120 on the same channel in a given location. Accordingly, in certain aspects, techniques are described herein for a user terminal 120 to select an AP 110 to communicate with based on a congestion level of the AP 110 and/or a congestion level of a channel that the AP 110 communicates on.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal. An RX data processor 242 processes (e.g., demodulates, deinterleaves, and decodes) each recovered uplink data symbol stream {s_{up,m}} in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. For example, the traffic data may include roaming information that may include location information regarding one or more APs 110. Further, the traffic data may include information identifying the AP 110 (e.g., BSSID, SSID, etc.).

The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal. The receiver spatial processing is performed in accordance with the CCMI, MMSE, or some other technique. An RX data processor 270 processes (e.g., demodulates, deinterleaves, and decodes) the recovered downlink data symbol stream to obtain decoded data for the user terminal. For example, the user terminal 120 may receive roaming information from an AP 110 that may include location information regarding one or more APs 110. Further, the user terminal 120 may receive data packets from one or more APs 110 on one or more channels.

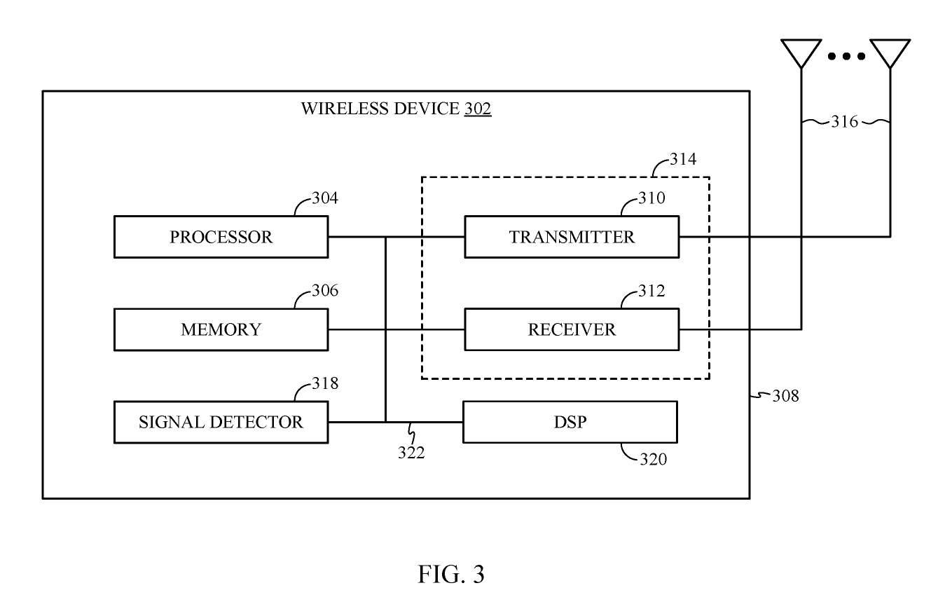

FIG. 3 illustrates various components that may be utilized in a wireless device 302 that may be employed within the system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein. In some instances, for example, the memory 306 of a user terminal 120 may store information indicative of a location of one or more access points 110 and/or information indicative of channels used by the one or more access points 110. A processor 304 of user terminal 120 may then use such information stored in memory 306 to determine proximity of the user terminal 120 to an access point 110, and to select or prioritize channels used by the access point 110 to scan, based on the proximity determination in accordance with the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A plurality of transmit antennas 316 may be attached to the housing 308 and electrically coupled to the transceiver 314. The wireless device 302 may also include (not shown) multiple transmitters, multiple receivers, and multiple transceivers. For example, the receiver 312 of a wireless device 302 may receive data packets and/or location information transmitted from transmitters 310 of one or more APs 110 on one or more channels. In certain aspects, the processor 304 may utilize information about the data packets (e.g., an identifier of an AP 110 associated with the data packet, a channel the packet was received on) to help select an AP 110 to communicate with.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Techniques for Access Point Roaming

In certain aspects, a network (e.g., Internet, local area network, wide area network, Intranet, etc.) may be accessible via a wireless network (e.g., system 100) that includes a plurality of APs (APs 110). Accordingly, a user terminal (e.g., user terminal 120) may determine which AP 110 to communicate with to access the network.

In certain aspects, a user terminal may initiate a roaming procedure to detect nearby access points to communicate with. For example, a user terminal may scan (passive scan and/or active scan) all available wireless channels (e.g., frequencies) an AP may use (e.g., 11 channels for APs utilizing the IEEE 802.11b/g/n protocol) to find APs available in the area (e.g., within communication range) of the user terminal. In particular, the user terminal may be configured to search for particular signals (e.g., beacons) or messages (e.g., packets) on each of the channels that may include information (e.g., BSSID, SSID, etc.) about each AP.

Further, the user terminal, based on the received signal, may determine a signal strength (e.g., signal-to-noise ratio (SNR)) for each AP on each of the one or more channels (e.g., a given AP may communicate on multiple channels, and the signal strength on the multiple channels may differ) utilized by each AP and select an AP and a channel based on the determined signal strength. For example, the user terminal may select the AP and channel with the highest signal strength of any APs detected to communicate with.

Scanning each available wireless channel may consume power and time of the user terminal for each channel scanned. In certain aspects, there may not be APs using all of the available wireless channels within communication range of the user terminal. Accordingly, in certain aspects, techniques are described herein for the user terminal to scan only the wireless channels being utilized by APs within communication range of the user terminal.

Further, in certain aspects, the signal strength of each AP alone may not be sufficient to select an appropriate AP and channel to communicate with. For example, the signal strength may indicate how strong a signal connection is between the user terminal and AP on a particular channel, but may not indicate the quality of service (QoS) the AP on the particular channel can provide to the user terminal. In particular, the AP may be communicating with a number of other user terminals and therefore handling traffic (e.g., data packets) for each of these user terminals. Therefore, the AP may be processing a high level of traffic (e.g., large number of data packets), which may degrade QoS for communications with the AP. For example, the AP may not be able to process communications (e.g. data packets) with the user terminal in a timely manner, or the high level of traffic may lead to interference between communications and dropped packets.

In addition, a channel itself may be utilized by one or more APs in a given geographic area, and therefore there may be traffic (e.g., data packets) from each of the APs and the user terminals they are communicating with on the channel. A high level of traffic (e.g., large number of data packets) on the channel may degrade QoS on the channel. For example, the high level of traffic may lead to interference between communications and dropped packets.

Accordingly, in certain aspects, techniques are described herein for a user terminal to select an AP to communicate with based on a congestion level of the AP and/or a congestion level of a channel.

In certain aspects, a user terminal may utilize information regarding APs in communication range (e.g., a sufficient signal strength between the user terminal and AP for communication, within a distance of the user terminal, etc.) of the user terminal as part of a roaming or AP selection process. In particular, the information (which may be referred to herein as “roaming information”) may comprise information indicative of a location of one or more APs (e.g., GPS coordinates, WiFi indoor navigation location, relative location (e.g., to another AP, such as within communication range of another AP), etc.), an identifier of the one or more APs (e.g., BSSID, SSID, etc.), and/or the channel each of the one or more APs utilize for communication (e.g., as defined in 802.11). The roaming information may comprise, for example, a table, mapping, or other suitable data format. The user terminal may then utilize this roaming information to determine which channels to scan for APs based on a location of the user terminal. For example, the user terminal may determine, based on the roaming information, channels being used by APs in communication range of the user terminal. The user terminal may then only scan for APs on the subset of channels being used by APs in communication range of the user terminal, as opposed to the entire set of channels that APs may possible utilize for communication. Thus, the amount of time and power used by the user terminal to scan channels is reduced.

In certain aspects, the user terminal may receive the roaming information from an AP that the user terminal is actively communicating with. For example, the user terminal may connect to and communicate with an AP that is part of a communication network (e.g., corporate network). The AP may have access to the roaming information and transmit the information (e.g., as a data frame, in a message, as a data packet, etc.) to the user terminal. For example, a back-end server of the communication network may have roaming information (e.g., location, channel, identifier, etc.) about one or more of the APs (e.g., all of the APs) that are a part of the communication network. The AP may access the roaming information from the back-end server and transmit the information to the user terminal wirelessly. For example, the AP may access the back-end server via a wired or wireless connection. The back-end server may store the roaming information in memory. Further, the AP may store the information in memory and transmit the information to the user terminal wirelessly.

The user terminal may utilize the received roaming information to select an AP to communicate with. For example, the user terminal may move, and while moving away from the AP it is currently communicating with, lose or have degraded connectivity with the AP (e.g., received signal strength indication (RSSI) is below a threshold level). Accordingly, the user terminal may determine its own location (e.g., based on GPS equipment in the user terminal, WiFi indoor navigation methods, motion sensor information at the user equipment, information about the AP that the user terminal was communicating with, etc.). The user terminal may then utilize the received roaming information to determine the channels utilized by APs within a communication range (e.g., within a particular distance, within a communication range of the AP that the user terminal was communicating with, etc.) of the user terminal. The user terminal may then only scan for APs on the subset of channels determined as being used by APs in communication range of the user terminal, as opposed to the entire set of channels that APs may possibly utilize for communication.

In certain aspects, when scanning channels (e.g., all channels, only certain channels such as based on roaming information, etc.), the user terminal may be configured to determine a congestion level for one or more APs and/or the channel scanned. For example, the user terminal may measure for a time period (e.g., 3 ms) a number of data packets (e.g., TX packets, RX packets, etc.) on the channel being scanned. In certain aspects, the user terminal may only measure the channel for data packets having an identifier (e.g., BSSID) that is associated with an AP (e.g., one or more APs) that the user terminal determines is in communication range with the AP, such as based on roaming information as discussed herein. In certain aspects, the user terminal may measure the channel for data packets regardless of the identifier in the data packet. The number of data packets measured on the channel may be indicative of a congestion level of the channel.

Further, in certain aspects, the user terminal may also determine an identifier associated with each of the number of data packets on each of the channels scanned. Accordingly, the user terminal may determine a number of data packets measured for a given AP by determining the number of data packets measured (e.g., on one or more channels) with an identifier of the given AP. The number of data packets measured having an identifier of an AP may be indicative of a congestion level of the AP.

In certain aspects, the user terminal may select/prioritize for selection an AP and channel based on the congestion level of the channel used by the AP, and/or the congestion level of the AP itself. Additionally, the user terminal may select/prioritize for selection an AP based on the proximity (e.g., distance) between the AP and the user terminal as determined by the user terminal. For example, the user terminal may have information about the location of the AP (e.g., roaming information) and determine its own location, and based on that, determine a proximity between the AP and the user terminal.

The wireless device may utilize one or more of these factors: congestion level of the channel and congestion level of the AP itself, (and optionally the proximity of the AP to the user terminal), to determine which access point to select to connect with. For example, the user terminal may perform a weighted average of the factors, or some other equation or algorithm, to determine which access point to select to connect with. For example, if the number of data packets is used to indicate congestion, and distance is used to indicate proximity, the AP and channel with the lowest score (e.g., weighted average) of one or more of these factors may be selected/prioritized for selection.

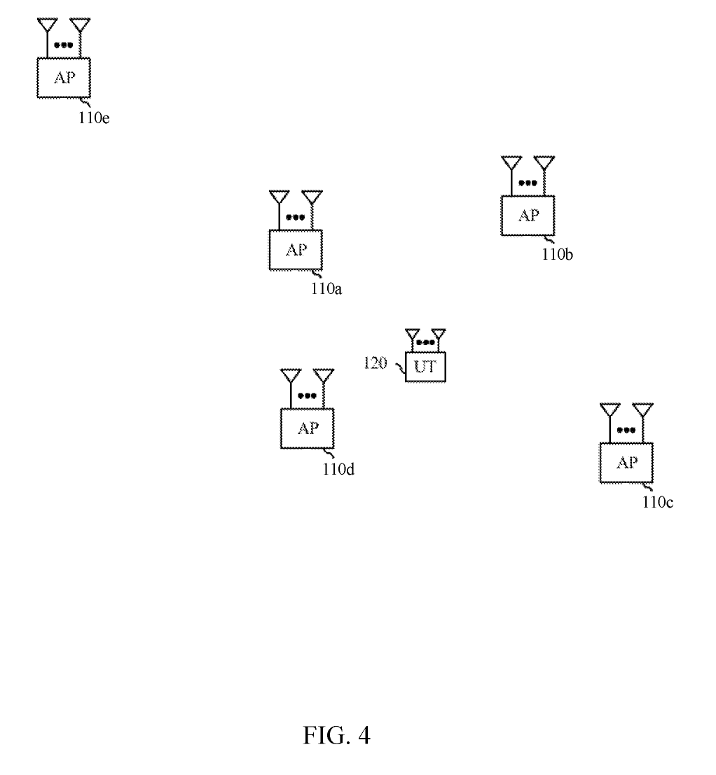

In one example, as shown with respect to FIG. 4, an AP 110a may communicate on channels 1 and 2, an AP 110b may communicate on channel 3, an AP 110c may communicate on channels 3 and 4, an AP 110d may communicate on channel 5, and an AP 110e may communication on channel 6.

A user terminal 120, may communicate with the AP 110d on channel 5, and may receive from the AP 110d roaming information for each of APs 110a-110e. In certain aspects, the user terminal 120 may determine its location, and based on its location and the roaming information, determine that each of APs 110a-110d are within communication range of the user terminal (but not AP 110e). For example, the user terminal 120 may determine the distance between its location and the location of each of the APs 110a-110d is below a threshold distance, and the distance between its location and the location of the AP 110e is greater than a threshold distance.

Accordingly, in certain aspects, the user terminal 120 may determine that channels 1, 2, 3, 4, and 5 are utilized by APs within communication range of the user terminal. The user terminal may then scan only channels 1-5 (and not channel 6 or any other channels) for APs to select for communication with.

In certain aspects, the user terminal 120 may measure a number of data packets associated with each of channels 1-5. Further, the user terminal 120 may determine a number of data packets associated with each of APs 110a-110d. For example, the number of data packets measured for each of channels 1-5 may be 100, 110, 103, 7, 52, respectively. Further, the number of data packets associated with each of APs 110a-110d may be 210, 53, 56, 53, respectively. The distance between the user terminal 120 and each of the APs 110a-110d may be 3, 5, 8, 2, respectively.

Accordingly, in certain aspects, if the user terminal 120 is configured to select an AP 110 to communicate with based on channel congestion level alone, the channel with the least congestion is channel 4. The only AP 110 utilizing channel 4 is AP 110c, so the user terminal 120 may select AP 110c and channel 4 for communication with the AP 110c.

If, in certain aspects, the user terminal 120 is configured to select an AP 110 to communicate with based on AP congestion level alone, the APs 110b and 110d have the least congestion. Therefore, the user terminal 120 may select either AP 110b or 110d and any channels they may utilize for communication.

If, in certain aspects, the user terminal 120 is configured to select an AP 110 to communicate with based on channel congestion level and AP congestion level, and the weighted average for the AP congestion is weighted twice as much as the channel congestion, then the following priority scores, as an example, would be associated with each AP and channel combination: AP 110a on channel 1=173; AP 110a on channel 2=177; AP 110b on channel 3=70; AP 110c on channel 3=72; AP 110c on channel 4=40; AP 110d on channel 5=53. Accordingly, the user terminal may select AP 110c and channel 4 for communication with the AP 110c.

If, in certain aspects, the user terminal 120 is configured to select an AP 110 to communicate with based on AP congestion level and proximity, and they are equally weighted, then the following priority scores, for example, would be associated with the each AP: AP 110a=107, AP 110b=29, AP 110c=32, AP 110d=28. Accordingly, the user terminal may select AP 110d to communicate with on any channel (in this case channel 5) supported by AP 110d.

If, in certain aspects, the user terminal 120 is configured to select an AP 110 to communicate with based on channel congestion level, AP congestion level, and proximity and the weighted average for the AP congestion is weighted twice as much as the channel congestion and proximity, then the following priority scores would be associated with each AP and channel combination: AP 110a on channel 1=131; AP 110a on channel 2=133; AP 110b on channel 3=54; AP 110c on channel 3=56; AP 110c on channel 4=32; AP 110d on channel 5=41. Accordingly, the user terminal may select AP 110c and channel 4 for communication with the AP 110c.

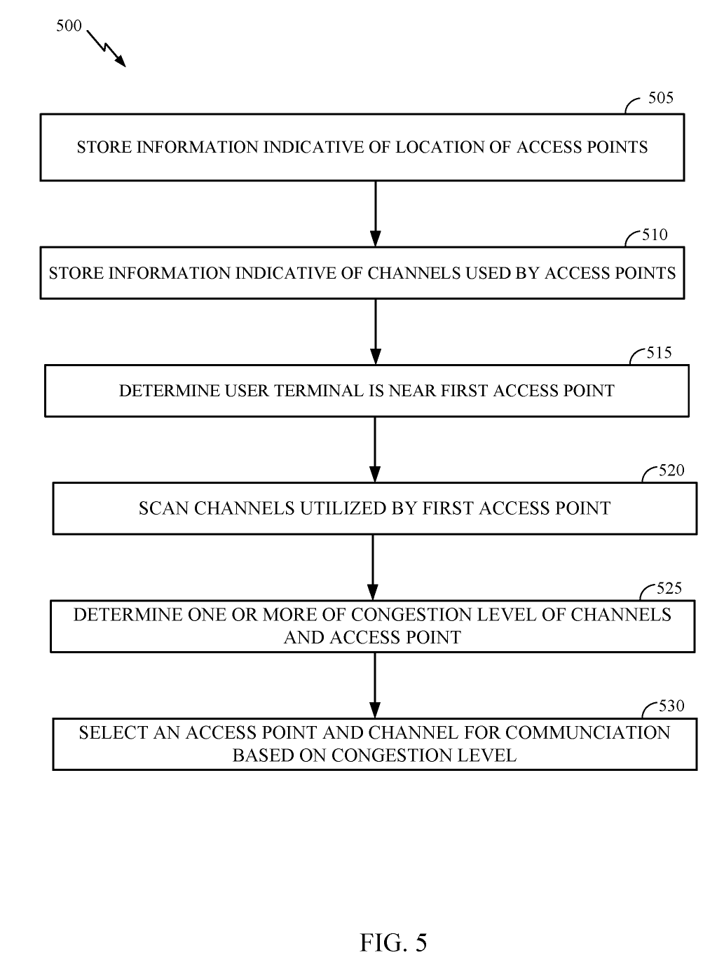

FIG. 5 illustrates example operations for access point selection, in accordance with certain aspects of the present disclosure. At 505, a user terminal (e.g., user terminal 120) receives and stores information indicative of location of a plurality of access points (e.g., APs 110) comprising a first access point from one of the plurality of access points. At 510, the user terminal receives and stores information indicative of a first subset of a plurality of channels used by the first access point from the one of the plurality of access points.

At 515, the user terminal determines, based on the information indicative of location of the plurality of access points, that the user terminal is near the first access point. For example, the user terminal may determine its own location and then determine if it is within a threshold distance of any of the plurality of access points, such as the first access point.

At 520, the user terminal scans the first subset of the plurality of channels based on determining the wireless device is near the first access point and the information indicative of the first subset. At 525, the user terminal determines, over a time period, at least one of a number of packets on each channel of the first subset and a number of packets associated with the first access point and any other access points of the plurality of access points the user terminal determines is within the threshold distance. At 530, the user terminal selects an access point (e.g., the first access point) to communicate with based on the at least one of the number of packets on each channel of the first subset and the number of packets associated with the first access point and any other access points of the plurality of access points the user terminal determines is within the threshold distance. The user terminal may automatically communicate with the selected access point, provide a list in prioritized order for selection by a user to initiate communication, etc.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication by a wireless device, the method comprising:
storing information indicative of location of a plurality of access points comprising a first access point;
storing information indicative of a first subset of a plurality of channels used by the first access point;
determining, based on the information indicative of location of the plurality of access points, the wireless device is near the first access point; and
scanning the first subset of the plurality of channels based on determining the wireless device is near the first access point and the information indicative of the first subset.

2. The method of claim 1, further comprising determining, over a time period, at least one of a number of data packets on each channel of the first subset and a number of data packets associated with the first access point.

3. The method of claim 1, further comprising selecting the first access point for communication based on the at least one of the number of data packets on each channel of the first subset and the number of data packets associated with the first access point.

4. The method of claim 3, further comprising selecting the first access point based on a proximity of the first access point to the wireless device.

5. The method of claim 1, further comprising:
storing information indicative of a second subset of the plurality of channels used by a second access point;
determining, based on the information indicative of location of the plurality of access points, the wireless device is near the first access point and the second access point;
scanning the second subset of the plurality of channels based on determining the wireless device is near the second access point and the information indicative of the second subset;
determining a first number of data packets on the first subset having an identifier associated with the first access point and a second number of data packets on the second subset having an identifier associated with the second access point; and
selecting one of the first access point and the second access point based on the first number of data packets and the second number of data packets.

6. The method of claim 1, further comprising determining a location of the wireless device, and wherein determining the wireless device is near the first access point is further based on the determined location of the wireless device.

7. The method of claim 1, further comprising receiving the information indicative of location of the plurality of access points comprising a first access point and information indicative of the first subset of the plurality of channels used by the first access point from one of the plurality of access points.

8. A wireless device comprising:
a memory configured to:
store information indicative of location of a plurality of access points comprising a first access point; and
store information indicative of a first subset of a plurality of channels used by the first access point; and
a processor configured to:
determine, based on the information indicative of location of the plurality of access points, the wireless device is near the first access point; and
scan the first subset of the plurality of channels based on determining the wireless device is near the first access point and the information indicative of the first subset.

9. The wireless device of claim 8, wherein the processor is further configured to determine, over a time period, at least one of a number of data packets on each channel of the first subset and a number of data packets associated with the first access point.

10. The wireless device of claim 8, wherein the processor is further configured to select the first access point for communication based on the at least one of the number of data packets on each channel of the first subset and the number of data packets associated with the first access point.

11. The wireless device of claim 10, wherein the processor is further configured to select the first access point based on a proximity of the first access point to the wireless device.

12. The wireless device of claim 8, wherein the processor is further configured to:
store information indicative of a second subset of the plurality of channels used by a second access point;
determine, based on the information indicative of location of the plurality of access points, the wireless device is near the first access point and the second access point;
scan the second subset of the plurality of channels based on determining the wireless device is near the second access point and the information indicative of the second subset;
determine a first number of data packets on the first subset having an identifier associated with the first access point and a second number of data packets on the second subset having an identifier associated with the second access point; and
select one of the first access point and the second access point based on the first number of data packets and the second number of data packets.

13. The wireless device of claim 8, wherein the processor is further configured to determine a location of the wireless device, and wherein to determine the wireless device is near the first access point is further based on the determined location of the wireless device.

14. The wireless device of claim 8, wherein the processor is further configured to receive the information indicative of location of the plurality of access points comprising a first access point and information indicative of the first subset of the plurality of channels used by the first access point from one of the plurality of access points.

15. A wireless device comprising:
means for storing information indicative of location of a plurality of access points comprising a first access point;
means for storing information indicative of a first subset of a plurality of channels used by the first access point;
means for determining, based on the information indicative of location of the plurality of access points, the wireless device is near the first access point; and
means for scanning the first subset of the plurality of channels based on determining the wireless device is near the first access point and the information indicative of the first subset.

16. The wireless device of claim 15, further comprising means for determining, over a time period, at least one of a number of data packets on each channel of the first subset and a number of data packets associated with the first access point.

17. The wireless device of claim 15, further comprising means for selecting the first access point for communication based on the at least one of the number of data packets on each channel of the first subset and the number of data packets associated with the first access point.

18. The wireless device of claim 17, further comprising means for selecting the first access point based on a proximity of the first access point to the wireless device.

19. The wireless device of claim 15, further comprising:
means for storing information indicative of a second subset of the plurality of channels used by a second access point;
means for determining, based on the information indicative of location of the plurality of access points, the wireless device is near the first access point and the second access point;
means for scanning the second subset of the plurality of channels based on determining the wireless device is near the second access point and the information indicative of the second subset;
means for determining a first number of data packets on the first subset having an identifier associated with the first access point and a second number of data packets on the second subset having an identifier associated with the second access point; and
means for selecting one of the first access point and the second access point based on the first number of data packets and the second number of data packets.

20. The wireless device of claim 15, further comprising means for receiving the information indicative of location of the plurality of access points comprising a first access point and information indicative of the first subset of the plurality of channels used by the first access point from one of the plurality of access points.
